(19) United States
(12) Patent Application Publication
(10) Pub. No.: US 2004/0263316 A1
(43) Pub. Date: Dec. 30, 2004

(54) Reprogrammable vehicle access control system

(75) Inventors: Peter J. Dix, Naperville, IL (US); Marius Bojarski, Bolingbroke, IL (US)

Correspondence Address: CNH AMERICA LLC, INTELLECTUAL PROPERTY LAW DEPARTMENT, PO BOX 1895, MS 641, NEW HOLLAND, PA, 17557, US

(73) Assignee: Case, LLC

(21) Appl. No.: 10/602,750

(22) Filed: Jun. 24, 2003

(51) Int. Cl. H04Q 1/00; G05B 19/00

(52) U.S. Cl. 340/5.23; 340/5.72; 340/5.61

(57) ABSTRACT

An access control system for controlling access to a vehicle and reconfiguring the vehicle to disable or enable operator smart keys is disclosed. An electronic controller in the vehicle receives signals indicating the presence of a master smart key in the vehicle. Once it determines that a master key is present, it permits one or more individual operator smart keys to be programmed. The identification numbers of these smart keys are stored in an electronic memory of the vehicle. Operators who subsequently insert these keys into the vehicle's ignition will be able to start and operate the vehicle.

### FIELD OF THE INVENTION

The invention relates to access control systems for work vehicles. More particularly, it relates to access control systems using smart keys and radio communications circuits to permit or deny access to one of more systems of a vehicle.

### BACKGROUND OF THE INVENTION

Vehicles such as rental cars, construction or agricultural vehicles are often intended for the use of many individuals. Typically, each user receives a key to operate the vehicle that is inserted into an ignition switch lock. The operator rotates the key in the lock, the switch makes contact, the electrical signals from the switch are transmitted to an electronic controller in the vehicle and the engine is started. In these scenarios, typically, the operator or operators of the vehicle having a key or a duplicate thereof have complete and full access to the vehicle.

For many vehicles, however, there may be multiple keys that require periodically supplementation with additional keys, or require certain keys to be disabled. “Disabled” in this context means the access normally provided by the key is reduced or eliminated. This access can be accessed to the entire vehicle as is the case with most automobiles in which an ignition key permits the operator to operate every device in the vehicle. It can also mean access to one or more subsystems of the vehicle, such as the engine, for purposes of starting, the transmission, for purposes of changing gears, any supplemental equipment mounted on the vehicle, such as front loaders, back hoes, forklifts, or other hydraulic cylinders that operate vehicle-related equipment.

Traditionally, the means of controlling access to the vehicle was by disabling (either partially or fully) a key. This process required a maintenance person, such as a locksmith, to go to the vehicle, remove the lock, move the positions of the tumblers in a lock, and replace the lock in the vehicle. Once this process occurred, the locksmith or maintenance person would then have to machine a new key to replace all of the outstanding keys, save the key that was to be disabled. All the operators of the vehicle other than the operator in possession of the disabled key would receive a newly machined key. The operator's key was to be disabled would not receive a new key, nor would his existing key work in the lock, since the pins or tumblers had been moved.

This traditional process has significant drawbacks. The most significant of these is the need for a locksmith or other skilled maintenance person to remove the lock and adjust it. This often requires significant disassembly of the steering column or dashboard of the vehicle as well as specific expertise in locksmithing.

What is needed, therefore, is a system for controlling access to a vehicle that is operable by one or more keys used by an associate of one or more operators. This method of controlling access should permit an owner of a vehicle to selectively disable one or more existing keys without requiring the replacement of existing keys whose access is to be preserved. It is an object of this invention to provide such a system.

### SUMMARY OF THE INVENTION

In accordance with the first embodiment of the invention, a method of reprogramming a vehicle and at least one smart key to provide access to the vehicle is disclosed that includes the steps of inserting a smart key into the vehicle, placing the vehicle into a programming mode if the first key is a master smart key, inserting subsequent smart keys into the vehicle and responsively configuring the vehicle and the second smart key to interoperate to provide access to the vehicle at some later time when the second smart key is inserted into the vehicle by itself.

This method may include the step of placing the vehicle in a programming mode for a predetermined period of time. The vehicle may be configured to exit the programming mode after a predetermined period of inactivity. The period of inactivity may be extended by inserting the second smart key and by the second smart key being sensed by an electronic controller in the vehicle. The vehicle may signal that it has entered the programming mode as well. It may signal to the operator that it has entered the mode by admitting light from an indicator light. Similarly, the vehicle may be configured to signal to the operator that it has exited the programming mode. It preferably does this by changing the state of the indicator light, preferably by turning it off.

Prior to the step of reprogramming the vehicle, the vehicle may have been operable by at least one operator's smart key. The vehicle may be configured to disable the operator's smart key. This disabling may be brought about by the process of entering the programming mode.

When the vehicle configures a smart key, it may disable two or more smart keys at the same time. These two or more operator's smart keys may be different than the smart key that is being programmed to interoperate with the vehicle to start the vehicle.

In accordance with the second embodiment of the invention, a method of controlling access to a vehicle by an otherwise access-granting operator smart key is provided that includes the steps of placing the vehicle into a programming mode, inserting a second operator's smart key different from the access-granting smart key, programming the second operator's smart key and the vehicle to interoperate to start the vehicle after entering the programming mode, substantially simultaneously programming the access-granting operator's smart key and the vehicle to interoperate to deny access to the vehicle to anyone using the access-granting operator's smart key, and exiting the programming mode.

The step of placing the vehicle in a programming mode may include the step of inserting a master key into an ignition switch of the vehicle, wherein the master key is different from the access-granting operator's smart key and the second operator's smart key. The step of placing the vehicle in a programming mode may include the step of placing the vehicle in the programming mode for a predetermined period of time.

The vehicle may signal its entry into the programming mode by emitting light from an indicator light. The vehicle may be configured to signal that it is exiting from the programming mode. This signaling of an exit from the programming mode may include the step of turning off the indicator light.

The method may also include the step of programming a third operator's smart key and the vehicle to interoperate to start the vehicle after entering the programming mode. This preferably occurs when the vehicle is in the programming mode in which the second operator's smart key was programming. It preferably occurs substantially simultaneously with the programming of the second operator's smart key and the vehicle to interoperate.

In accordance with the third embodiment of the invention, a system for controlling access to a vehicle is provided that includes a controller in the vehicle that includes a radio transceiver configured to communicate with a smart key, a master key having at least one numeric value stored therein to indicate the identity of the master smart key, and the first operator's smart key having at least a second numeric value stored therein to indicate the identity of the first operabr's smart key, wherein the controller is configured to communicate with the master smart key when the master smart key is inserted in the vehicle, to receive the at least one numeric value from the master key, to enter into a vehicle access programming mode responsive to receiving the at least one numeric value, and to receive the first operator's smart key while in the programming mode, and to program the vehicle and the first operator's smart key to interoperate to provide vehicle access to the first operator's smart key.

The access provided to the first operator's smart key may be the ability to start the vehicle's engine. The system may also include visual indicia that are operably coupled to the controller, wherein the controller is configured to turn the indicia on when the vehicle enters the programming mode. The controller may be configured to exit the programming mode after a predetermined time interval after it enters the programming mode. The controller may be configured to extend the predetermined time interval whenever any operator's smart key is inserted into the vehicle.

### BRIEF DESCRIPTION OF THE DRAWINGS

FIG. 1 illustrates the overall system, including a vehicle with a control system that is configured to communicate with a radio transponder.

FIG. 2 is a detailed view of the transponder showing the microcontroller, digital memory and the antenna.

FIG. 3 is a detailed view of the vehicle's control system showing the plurality of vehicle subsystems or components and their interconnections, including the reader that reads the transponder.

FIG. 4 illustrates an exemplary controller of those shown in FIG. 3.

FIG. 5 is a flow chart showing the operation of a monitoring controller, ignition switch, reader circuit, and a smart key in granting or preventing access to vehicle 10.

FIG. 6 is a flow chart illustrating how a master key, enables the reprogramming of one or more operator smart keys.

The invention will become more fully understood from the following detailed description when taken in conjunction with the accompanying drawings. Like reference numerals refer to like parts.

### DETAILED DESCRIPTION OF THE PREFERRED EMBODIMENT

Before we can discuss the operation of the access-granting and key disabling features of the present system, we must first describe other forms of access, the structure of the smart keys, and the electronic control system of the vehicle generally. Once we have described this interoperation of the vehicle's control system and smart keys generally, we will describe the reprogrammable access control capabilities in detail below.

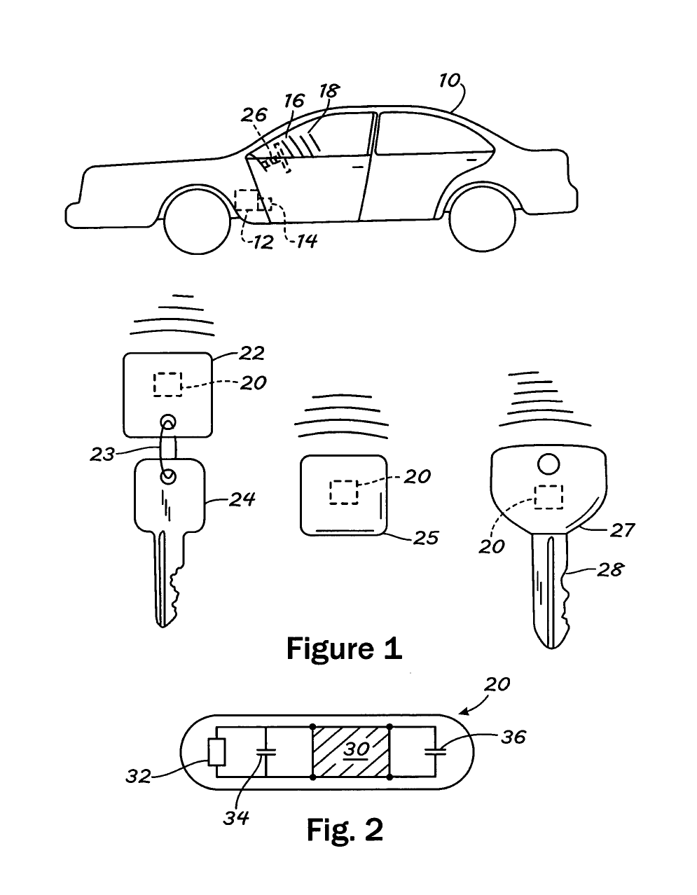

Referring to FIG. 1, a vehicle 10 has a control system 12 that includes a reader circuit 14. This reader circuit generates an electromagnetic field 16 into the operator's station 18 of the vehicle and preferably in the local vicinity of the station. This electromagnetic field impinges on a transponder 20 that is carried by the operator to the vehicle. The transponder 20 is responsive to radio signals transmitted by the vehicle, as described below. When the operator is adjacent to or in the vehicle, the electromagnetic field is sufficiently strong that it can energize transponder 20. In response to being energized, the transponder transmits data over radio waves to the reader circuit which reads the data and takes predetermined actions based upon that data.

The transponder may be provided in one of several preferred forms. Transponder 20 may be in the form of a key fob, preferably molded into a plastic case 22 impervious to moisture (under typical operating conditions). Case 22 is mechanically coupled to an ignition key 24 by strap 23. Key 24 is configured to fit into and turn ignition switch 26 of the vehicle. In this arrangement the ignition key permits the operator to start the vehicle engine. Transponder 20 is accessed by the vehicle to determine what vehicle functions, operations, systems or sub-systems the operator is permitted or not permitted to use.

Transponder 20 may alternatively be molded into a thin credit card-sized sheath 25. Again, it is preferably impervious to moisture under ordinary operating conditions. In this form, transponder 20 is not mechanically coupled to a key, and is therefore easily carried in the operator's wallet, shirt pocket or pants pocket.

Transponder 20 may alternatively be molded into the plastic handgrip 27 of an ignition key 28.

Any of these arrangements can be used as a smart key to control access to the vehicle. In the preferred embodiment, the mechanical key portion of the ignition keys 24, 28 is thin and elongate having a plurality of mechanical detents to engage mating pins or tumblers in the lock in the traditional manner of mechanical locks as shown in FIG. 1. Alternatively, rather than the elongate familiar key shape shown in FIG. 1, the mechanical key portion may be cylindrical, with detents cut into an end of the cylinder. As yet another alternative, the detents may be disposed not just on one edge of the elongate portion as shown in FIG. 1, but on opposing edges or on a face or opposing faces of the elongated key portion. In any event, the mechanical portion of ignition keys 24, 28 is configured to engage and turn the ignition key switch 26 by the interoperation of the detents and internal lock elements in the ignition key switch.

Referring now to FIG. 2, the transponder includes a microcontroller 30 in an integrated circuit package, an antenna 32 and a resonance capacitor 34 in series. A charge capacitor 36 is coupled to package and functions as a power source. The transponder is preferably one of Texas Instruments RFID products, more preferably one of their Multipage Transponders (MPT), Selective Addressable Multipage Transponders (SAMPT), or Selective Addressable Multipage Transponders (Secure) (SAMPTS). Other's that are acceptable include Microchip's, Motorola's, or Temic's transponders. These microcontrollers are programmed to provide individual and selectable read (and read-write) access to their internal digital memory. Their internal memory space preferably contains 80 or more bits of stored information. The memory is preferably arranged in separately addressable pages of memory.

To energize the transponder, it is placed in an oscillating electromagnetic field 16 generated by the reader circuit 14 (FIG. 1). This field oscillates at the resonant frequency of the antenna 32 and resonance capacitor 34, causing an oscillating current to build up between these two components. This oscillating current charges capacitor 36. The charge saved in capacitor 36 is then used to power microcontroller 30.

Once microcontroller 30 is powered, it filters the signal that is generated in the antenna and resonance capacitor and extracts superimposed data carried by the electromagnetic field. Based on preprogrammed instructions that it contains in an integral read-only memory, microcontroller 30 responds to the received data, which includes read (and preferably write) instructions. If the received instructions are read instructions, microcontroller 30 selects a particular data item from its internal memory to be transmitted to the vehicle, and transmits this data via antenna 32. Reader circuit 14 receives the information transmitted by the transponder, and processes it accordingly. If the instructions are write instructions, microcontroller 30 receives data from the vehicle via field 16 and stores this data in its internal memory.

In a first embodiment, the data stored in the memory of microcontroller 30 may include numeric values that are remotely downloaded into the transponder and are indicative of (1) a total distance which the operator is permitted to travel, (2) a geographical area in which the vehicle may only be operated, (3) allowed times and dates of operation, such as (i) the specific hours during the day when the vehicle may be operated or (ii) the specific dates on which it may be operated, (4) the total time of permitted operation, and (4) the permitted subsystems that the operator is allowed to use.

In a second embodiment, the data stored in microcontroller 30 of the transponder may also include data downloaded from the vehicle itself, such as (1) the distance traveled by the vehicle, (2) the date and times of specific events, such as the time the vehicle was started, the time the vehicle was stopped, (3) time-triggered elapse records, such as service reminders, and a vehicle rental period expiring, (4) vehicle conditions, such as a threshold or maximum engine load experienced by the vehicle during operation, (4) the current odometer reading, (5) fault or error conditions experienced during operation, such as low fuel conditions, low oil or oil pressure conditions, engine coolant over-temperature, engine electrical output too low or too high, and (6) amount of consumables remaining in vehicle, such as the fuel level, coolant level, oil level, and hydraulic fluid level.

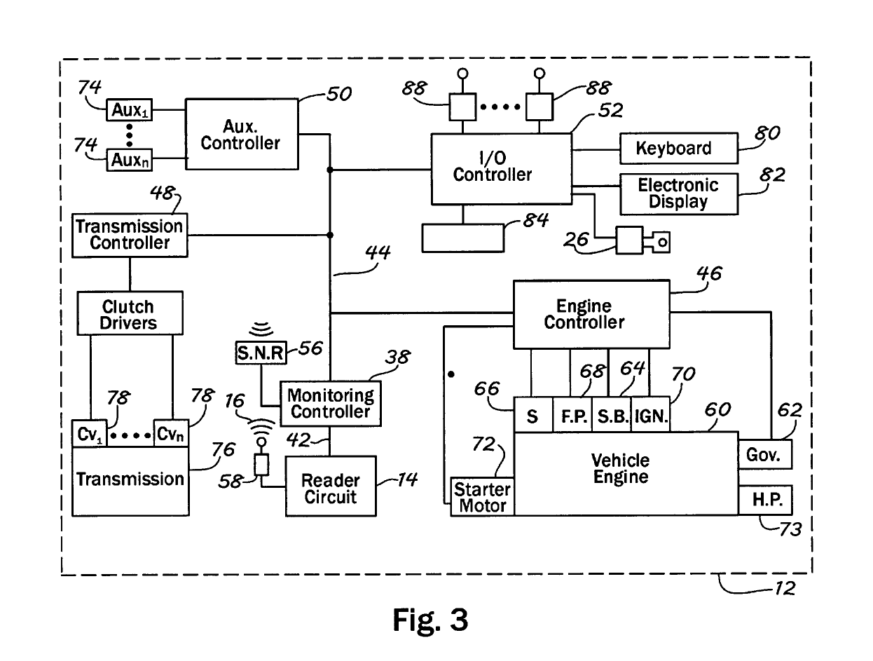

FIG. 3 shows vehicle control system 12 of FIG. 1 in more detail. Control system 12 includes a vehicle status and monitoring controller 38 that is coupled to reader circuit 14 over an RS485 telecommunications link 42. System 12 also includes several other microprocessor-based controllers that are coupled together with monitoring controller 38 by vehicle serial bus 44. These controllers include an engine controller 46, a transmission controller 48, an auxiliary controller 50, and a user I/O controller 52.

Monitoring controller 38 is coupled to a satellite navigation receiver 56 that is configured to receive radio transmissions from satellites and to convert them into data indicative of the vehicle's current location such as latitude and longitude. Controller 38 is also coupled to reader circuit 14 that communicates with transponder 20.

Reader circuit 14 includes a radio frequency module, such as Texas Instruments' RI-RFM-007B and a control module such as Texas Instruments' RI-CTL-MB6A. The control module is the interface between the radio frequency module and controller 38. The control module controls the transmitting and receiving functions of the radio frequency module according to commands sent over the serial connection from controller 38 to the control module. The control module decodes the received RF signals, checks their validity and handles their conversion to a standard serial interface protocol—which, in the preferred embodiment, includes an RS-485 interface. Hence the RS 485 serial communication link 42 between reader circuit 14 and controller 38.

Controller 38 directs reader circuit 14 by issuing several commands over the RS485 connection to the control module. These commands include a query command to query for any transponder in range, and a specific query command to query for a specific transponder by its embedded identification number. While it is possible for all the vehicle and operator information in transponder 20 to be transmitted as one long string of bits, it is more efficient and fast to arrange such data into a series of “pages” in transponder 20, pages that can be individually retrieved by controller 38 on a page-by-page basis. In this manner, controller 38 need not wait until the entire contents of transponder 20 are downloaded to reader circuit 14 and hence to controller 38, but can selectively request specific items of information that are specific to the particular task that controller 38 is attempting to perform.

This specific query command causes reader circuit 14 to generate and transmit radio signals through antenna 58 into the surrounding environment of the operator's station and near proximity to the operator's station. If any transponder is close enough to be energized by the electromagnetic field 16 generated by antenna 58, it is energized and internally checks to see if it has the identification number broadcast by antenna 58. If so, it responds with an affirmative message, and thereby establishes a communication session with controller 38.

On the other hand, if a general query is transmitted, all transponders in the vicinity (i.e. close enough to be energized) will respond to the transmission with a response that includes their identification number. The transponders are a part of a system wherein each operator has his own transponder and is preferably uniquely identified by their transponders. Hence, each transponder in the fleet management system preferably has a different identification number stored in its memory in microcontroller 30, and thus can uniquely identify the person carrying the transponder. By using the general query, reader circuit 14 can single out and identify any transponder within range. It can subsequently single out and communicate with each transponder in range by transmitting successive specific queries that successively identify each of the transponders in the vicinity.

Once the reader circuit 14 establishes the existence of a particular transponder or transponders within the range of its antenna 58, it then continues the communications session by sending a request to the transponder to download information from the memory of microprocessor 30 to the reader circuit and thence to controller 38 for processing. Transponders currently commercially available have a limited amount of memory that can be written to or read from. As transponders develop, more and more memory space in transponders will be available for storage and retrieval. As a result, it may take a significant period of time to transmit all the operator information from the transponder to the vehicle when the operator approaches the vehicle to start it. As a result, the operator may wait for a significant period of time for the initial communication session to complete and controller 38 to permit the vehicle to be operated.

To speed up this initial communication between the transponder and the vehicle, reader circuit 14 can continuously and periodically transmit general or specific queries. In this manner, as a potential operator with a transponder approaches the vehicle or enters the vehicle's cabin or operator's station, the initial communication between the transponder and the vehicle can commence automatically without special operator intervention to initiate it. Once the operator is within range, the transponder will be automatically energized by field 16, and will transmit the information requested by the vehicle even before the operator has situated himself in the operator's seat and attempts to start the vehicle's engine.

By the time the operator indicates that he wishes to start the vehicle, such as by operating the ignition switch 26 with a key, or pressing an “engine start” or other similar button on keyboard 80, the initial communication between the operator's transponder and the vehicle's control system will have provided the control system with the information it needs to determine whether or not the operator is permitted to operate the vehicle. There will be no significant delay between the time the operator starts the engine and the vehicle gets underway.

There are drawbacks to this automatic and periodic querying in the vicinity of the vehicle, however. It can cause the vehicle's battery to drain. If the electromagnetic field extends outside the vehicle, the transponder of someone passing nearby the vehicle can be inadvertently energized, and the vehicle would then mistakenly gather information and prepare for vehicle operation. Someone could sit in the vehicle briefly, inadvertently establish communication with the vehicle control system due to its automatic querying, then depart after the vehicle gathered data from that person's transponder and assumed that person was going to operate the vehicle. A second person might then sit in the vehicle and operate it. This would be especially problematic if there were no special device, such as a key, required for operation.

To reduce the risk of a stray passing transponder initializing the vehicle, the transponder 20 and the antenna 58 of reader circuit 14 are preferably configured such that the transponder must actually be inside the vehicle before the electromagnetic field is sufficient to energize the transponder. Alternatively, they are configured such that the transponder is energized even when outside the vehicle, but the radio signal transmitted by the transponder is not sufficiently strong (from outside the vehicle) to return to the circuit 14. In either case, a passing transponder will not inadvertently establish communication with reader circuit 14.

In a further alternative embodiment, controller 38 can be configured to wait until someone engages a switch on the vehicle (preferably, but not necessarily ignition switch 26) before it signals reader circuit 14 to generate the electromagnetic field that energizes the transponders and subsequently to query the transponder (or transponders, as the case may be) in the vicinity of reader 14. By waiting until the operator engages a switch or other user interface before generating the electromagnetic field in response to an affirmative action by the operator, vehicle battery life is substantially extended.

In the event ignition switch 26 is used, the switch will be permitted to start the vehicle in a typical fashion, but any additional functions will not be enabled until controller 38 has received the data stored in transponder 20 and determined whether the operator is permitted to operate specific vehicle systems. During this process, controller 38 will not authorize the transmission controller to engage the transmission in a gear ratio. Once the data has been received by reader circuit 14, it is formatted and transmitted to controller 38 for processing.

Controller 38 also communicates with the other controllers by transmitting packets of data on the communications bus 44 extending between the various controllers on the vehicle. These packets of data may be broadcast to all the controllers with a header indicating the contents of the packet, or they may be transmitted to individual controllers with a header including a controller address identifying the controller to which they are addressed, as well as information indicating the contents of the data in the packet. Any of the data items received from transponder 20 can be transmitted in this manner.

Controller 38 receives packets of data indicative of vehicle status and events that are transmitted by the other controllers on the CAN bus such as the engine RPM, engine load, engine throttle position, the distance traveled, elapsed time since last oil change, the oil change intervals, the engine oil temperature, the engine coolant temperature, the engine oil level, the elapsed hours of engine operation, error conditions experienced by any of the controllers, the vehicle's geographical location, as well as any operator requests to operate specific subsystems or subcomponents of the vehicle.

Controller 38 periodically compares the data it has received from the other controllers and from its own sensors (the receiver 58) with the transponder data it received from the transponder to determine whether the operator has attempted to exceed any of the operational limits that were indicated by the transponder data. For example, if the engine may be operated for only a predetermined number of hours, controller 38 compares the elapsed engine hour data received from the engine controller with the permitted hours received from the transponder and performs one or more predetermined functions based upon the result of that comparison.

If these limits are exceeded, and depending upon the priority of the particular transponder limits, controller 38 will transmit a packet that shuts down a particular vehicle subsystem. For example, this packet can shut the particular vehicle subsystem by directing the engine controller 46 to shut down the fuel pump, the ignition system, or to limit the speed of the vehicle or the engine. At substantially the same time, controller 38 will preferably transmit a packet to I/O controller 52 commanding it to display a message indicating what limit has been exceeded.

In other cases, especially if the priority of the limits is lower, controller 38 may only send a packet to the I/O controller 52 telling it to display a message indicating that a particular limit has been exceeded, but not sending a packet to engine controller 46 directing it to shut down any or all of the sub-systems it controls. For example, if the vehicle is a rental car and it is traveling down the highway at 60 miles per hour, common sense would dictate that the engine cannot be stopped immediately. Hence, exceeding a permitted distance of travel or permitted zone of travel while the vehicle is moving at a predetermined speed or greater would be a low priority message and controller 38 would not shut the engine sub-systems down. On the other hand, if the operator is only permitted to use the car's radio for 10 miles, the radio could indeed be shut down immediately causing no problems (a high priority message).

Engine controller 46 is coupled to the vehicle's engine 60 which it monitors and controls. Engine 60 may be a spark ignition or a diesel engine. The way engine controller 46 controls the engine is by sending a signal to the engine's governor 62 typically indicative of a commanded fuel flow rate or power output. The governor, in response to this signal, varies the rack position of the fuel injector system (i.e. a mechanical system), or transmits an electronic signal to each of the fuel injectors (if an electrical injector system). Alternatively, it may open or close a combustion air valve or “throttle valve” that regulates the flow of air to each combustion chamber of the engine. The governor, if electronic, transmits a signal back to engine controller 46 that is indicative of the speed of the engine. As an alternative, a separate engine speed sensor 64 can be provided, such as a shaft speed sensor or a sensor that monitors the fluctuations in electricity coming out of the engine's alternator. The frequencies of these fluctuations are proportional to the speed of the engine.

Engine controller 46 is also coupled to several sensors 66 that are themselves coupled to the engine to generate signals indicative of oil pressure (oil pressure sensor), oil temperature (oil temperature sensor), coolant water temperature (coolant temperature sensor), engine speed (sensor 64) and engine load.

Engine controller 46 is also coupled to fuel pump 68 to either enable or disable the fuel pump by connecting or disconnecting power to the pump. The fuel pump itself uses mechanical or electrical feedback to automatically maintain the desired fuel pressure of the fuel provided to the engine.

Engine controller 46 is also coupled to ignition system 70 of the engine (in the case of spark ignition engines) to either energize or de-energize the ignition under computer control. In addition, engine controller 46 is coupled to the engine starting motor 72 to turn motor 72 on or off under computer control.

The engine controller is therefore configured to monitor various conditions of the engine, as well as directly control the operation of the engine by selectively enabling or disabling engine subsystems such as ignition, fuel, and starting.

Auxiliary controller 50 controls the operation of various hydraulically powered subsystems of the vehicle. Engine 60 drives a hydraulic pump 73 that provides a source of pressurized hydraulic fluid. This fluid is controlled and directed by auxiliary controller 50. Auxiliary controller 50 is coupled to and drives several auxiliary hydraulic valves 74 (AUX₁ . . . AUXₙ). These valves are typically on-off valves or pulse-width modulated proportional control valves that regulate the flow of hydraulic fluid. If vehicle 10 is a backhoe or has a backhoe attachment, for example, controller 50 and valves 74 controls the flow of fluid to a boom swing cylinder, a boom lift cylinder, a dipper cylinder and a bucket cylinder, which are each coupled to and controlled by at least one aux valve 74. One or more additional valves are provided to control the flow of hydraulic fluid to or from various hydraulically driven implements that are mounted on the end of the backhoe arm. If the vehicle is a dump truck, for example, controller 50 controls the flow of fluid to and from the cylinders that lift the box of the truck to dump it. If the vehicle is a loader, loader/backhoe, bulldozer, or skid steer loader, for example, controller 50 regulates the flow of fluid to and from the arm and bucket cylinders (as the case may be) that raise, lower, and tilt the bucket. The operator can be permitted or denied the operation of any or all of these subsystems by data in the transponder.

Transmission controller 48 controls the shifting of the vehicle's transmission 76. Controller 48 is coupled to and drives several clutch control valves 78 (CV₁ . . . CVₙ in FIG. 3) that in turn control the flow of hydraulic fluid to and from hydraulic clutches in the transmission. These valves, depending upon the type of clutches employed, may be on-off valves or proportional control valves.

Controller 48 is also configured to select the particular clutches necessary to engage the transmission in a particular gear ratio and sequentially energizes the clutch control valves 78 such that appropriate gears and shafts are engaged. The transmission is preferably a power shift transmission in which most, if not all, of the gear ratios of the transmission are selectable by filling one or more hydraulic clutches coupled to valves 78.

Input/output controller 52 drives and responds to operator interface devices including keyboard 80, display 82, audio enunciator 84, and optional key switch 26. In addition, one or more control levers 88 are provided for operating the valves controlled by controller 50.

It is through these input devices that the operator communicates with the vehicle. The keyboard may be arranged as a closely spaced array of buttons, or the buttons may be spread out around the operator's station to make them easier to operate.

Display 82 is preferably a liquid crystal display, an electroluminescent display or the like having a region for displaying alphanumeric messages. This region is configured to display a plurality of different messages indicating the data stored in transponder 20 as well as information regarding the status of the vehicle, such as alarm conditions including (1) engine coolant water temperature too high, (2) engine coolant level too low, (3) engine lubricating oil temperature too high, (4) engine lubricating oil pressure too low, (5) hydraulic fluid pressure too low, or (6) hydraulic fluid temperature too high. Display 82 is preferably a multi-line display.

In addition, display 82 is configured to display the status of the vehicle based upon data retrieved from the transponder. For example, if the operator is not permitted to operate a particular subsystem of the vehicle as indicated by the data downloaded to controller 38 from transponder 20, display 82 is configured to display these limitations on display 82 at substantially the same time that the operator starts the vehicle. Some of the data downloaded from the transponder to controller 38 indicates limits on use of the vehicle such as the number of hours of permitted use, the total distance of permitted travel, the maximum speed of permitted operation, the maximum load on the engine and the geographical area in which the vehicle is permitted to operate. These are conditional limitations, since they may never prevent use of the vehicle unless they are exceeded. For this reason, display 82 is also configured to display messages as these limits are approached.

If the vehicle approaches its geographical limits of operation as determined by the controller 38, for example, display 82 is programmed to display an alphanumeric message indicating this impending condition with a notice such as “This vehicle cannot be used outside of Michigan.”

When the operator approaches the maximum number of hours or miles of operation as determined by controller 38, display 82 is configured to display an alphanumeric message indicating this impeding condition, by displaying a message such as “Only 15 minutes left to operate the vehicle” or “Only fifteen miles left to operate the vehicle”. Similar messages are displayed when the vehicle approaches its maximum permitted speed and maximum permitted load as indicated by data downloaded from the transponder.

Other data downloaded from transponder 20 may indicate other limits on operation, such as the operator not being permitted to operate specific sub-systems of the vehicle, such as (1) the various hydraulically actuated devices (e.g., front loader, backhoe, dozer blade, fork lift, or road grader blade hydraulic actuators) that are attached to or an integral part of the vehicle, or (2) to gain physical access to parts of the vehicle, such as by preventing the glove compartment latch, engine compartment latch, gas tank cover latch or trunk latch from being operated, which would thereby permit access to these compartments, or (3) preventing various accessories from being operated, such as a radio, vehicle heater, air conditioner, tape or CD player, navigation computer, or TV.

In the case of these various devices and subsystems that may be impermissible to use, display 82 is configured to generate an alert message at substantially the same time that the operator attempts to use them by displaying an appropriate message preferably indicating both (1) that use is not permitted, and (2) the device the operator attempted to operate.

This message could be displayed symbolically. For example, if the transponder indicated that the backhoe was not permitted to be used, it could display a device symbol in the shape of the backhoe (the device) with the international “not permitted” symbol of a red circle with a diagonal line through it superimposed on top of the device symbol when the operator moved levers 88 in an attempt to move the backhoe by operating valves 74. Alternatively, this message could be displayed in words. For example: “The backhoe may not be used”.

Input/output controller 52 is also configured to energize audio alarm 84 substantially simultaneously with the appearance of a message to draw the operator's attention away from the device he is attempting (and not permitted) to operate and to the appropriate message on display 82.

All the controllers on bus 44 are in constant communication with each other while the vehicle is operated. As the transmission controller changes gear ratios and shifts the transmission, it packetizes information indicating the gear ratio or occurrence of a shift and places it on the bus for the other controllers to use.

As the engine controller controls the operation of the engine, it packetizes information relating to the engine and places that information on the bus for the other controllers to use. This information includes such data as the engine speed, values indicative of the various engine oil and water temperatures and pressures provided by the sensors, and the total elapsed hours of engine operation discussed above.

As the auxiliary controller operates the various hydraulic valves, it packetizes information indicating which valves 74 are open and closed, and by how much they are opened and closed, and places these packets on the bus for the other controllers to use.

As the input/output controller monitors the user input devices including levers 74, keyboard 80 and switch 86, it packetizes these operator requests and places the packets on the bus indicating the particular operational requests made by the operator. These include, but are not limited to, packets indicating the operator's attempts to operate the various subsystems of the vehicle he is not permitted to operate.

The communications controller similarly packetizes the data it receives from the transponder and places it on the bus for the other controllers to use.

In this manner each controller is made aware of the state of the various devices and actuators controlled or monitored by the other controllers.

Just as the various controllers are configured to transmit packetized information on bus 44 for use by other controllers, they are also configured to receive packetized information transmitted from the other controllers and use this data internally for their own programmed operations.

Controller 38, for example monitors the status of information transmitted by the other controllers that is indicative of the status of the other controllers and the subsystems and components to which they are attached. For example, when the operator manipulates levers 88 in an attempt to move the various hydraulic components that are controlled by auxiliary controller 50, I/O controller 52 places a packet indicative of this request on bus 44. Controller 38 reads this packet and compares the operator request with the data it has received from transponder 20 and determines whether the operator is permitted to operate the requested hydraulic device. If so, controller 38 signals its approval by packetizing and forwarding the request to controller 50. Alternatively, if the operator is not permitted to operate the device (typically a hydraulic actuator or actuators controlled by valves 74), controller 38 will not forward the operator request to controller 50. Instead, controller 50 will send a packet to controller 52 directing it to display a message indicating that the requested operation is not permitted. Controller 52, when it receives this packet of information will responsively display an alert message as discussed above, and will optionally energize enunciator 84, causing it to generate a sound to get the operator's attention.

As engine controller 46 operates, it transmits packets on bus 44 indicative of the elapsed time the engine has been operated. Controller 38 receives this information, compares it with any time limit of engine operation that it received from transponder 20 and, if the vehicle is approaching the time limit of engine operation, transmits a packetized message to I/O controller 52 directing it to display a message indicative of the approaching time limit. Controller 52 will responsively display the requested message and will preferably energize enunciator 84 causing it to generate a sound to get the operator's attention.

Controller 38 also receives the data indicative of the vehicle's current position from receiver 58, and compares it with the data indicative of the permitted geographical area of operation received from transponder 20. If the vehicle is approaching the geographical limit of operation or has exceeded it, for example, controller 38 transmits a packet to I/O controller 52 directing it to generate a corresponding message. Controller 52 responsively displays that message.

Engine controller 46 is configured to transmit packets of data indicative of elapsed engine hours, engine RPM and engine load among other data. Controller 38 receives these packets and compares this data with the data indicative of permitted engine speed and engine load that were downloaded from transponder 20. If the engine RPM or load approaches the permitted engine RPM or load, controller 38 transmits a packet to I/O controller 52 indicative of these conditions. Controller 52 responsively transmits a message to display 84 indicates this condition. In addition, controller 38 transmits packetized data to engine controller 46 directing engine controller 46 to limit the RPM and load to the approved limits indicated by the data retrieved from transponder 20. Engine controller 46 will, in response, prevent the engine from exceeding the load and RPM limit by controlling the engine governor or throttle valve to maintain the engine at or below the load or RPM limit. Alternatively, controller 38 may be configured to transmit the engine speed and load limits to engine controller 46 on startup (when controller 38 reads the data stored in transponder 20), and engine controller 46 can be configured to maintain these speed and load limits by itself, without input from controller 38 by periodically comparing the actual speed and load with the speed and load limits sent to it by controller 38 and automatically preventing the engine from exceeding these limits.

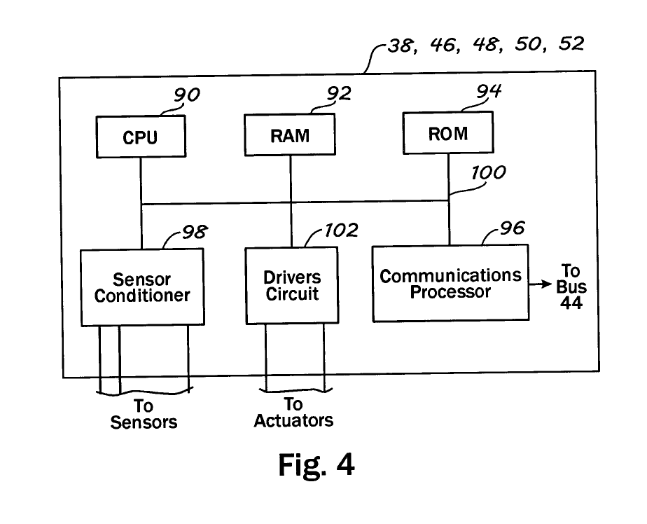

Referring now to FIG. 4, each controller (including controller 38) of FIG. 3, has a microprocessor 90, RAM memory 92 and ROM memory 94, as well as a dedicated communications processor 96 configured to handle all communications over bus 44 with the other controllers on the bus (FIG. 3).

Each controller also includes a sensor conditioning circuit 98 that interfaces the sensor signals (such as sensors 66, levers 88, keyboard 80, switch 26) to bus 100. Circuit 98 filters and buffers the signals to eliminate noise, and may include sample-and-hold sub-circuits as well as analog-to-digital converters for processing analog sensor signals.

In addition, each controller includes a driver circuit 102 that controls the application of power to the actuators, including, without limitation, the valves driven by the transmission and auxiliary controllers, the fuel pump, governor and ignition system driven by the engine controller, and the electronic display driven by the I/O controller. The microprocessor, RAM, ROM, and communications processor are all coupled together by control/data/address bus 100 within each controller.

The ROM memory 94 contains the programmed instructions that control the operation of the microprocessor 90 in that controller.

The RAM memory 92 is used to store working variables required by the microprocessor. A particularly preferred processor for each of the controllers is a MC68HC11, MC68HC908AZ60, MPC555, or MPC565 microprocessors by Motorola. The preferred dedicated communications processor is any of the standalone CAN processors, such as those manufactured by Microchip or Phillips. The advantage to the Motorola 68HC908AZ60, the MPC555, and the MPC 565 processors is that they include both the communications processor and the microprocessor on the same die and therefore in a single package.

Thus, each of the controllers shown in FIG. 3 is coupled to the other controllers of FIG. 3 by a serial communications bus 44. Each controller has its own internal communications bus 100 that couples the microprocessor, RAM, ROM, and dedicated communications processor of each controller. Each controller likewise controls one or more different subsystems of the vehicle and receives necessary data regarding the control of its subsystems from the other controllers.

While the embodiments illustrated in the FIGURES and described above are presently preferred, it should be understood that these embodiments are offered by way of example only. For example, the principles of the present invention may find applications in automotive, agricultural and construction vehicles. The transponder may be a self-powered radio transmitter or transmitter/receiver. The invention is not limited to a particular embodiment, but extends to various modifications that nevertheless fall within the scope of the appended claims.

### Access Control

In the sections above, the construction and operation of the vehicle with each of many differently configured smart keys is described. “Smart keys” as used herein mean the combination of a mechanical ignition key that operates the ignition switch, such as illustrated in FIG. 1, and a radio communications device such as transponder or transceiver 20, which also illustrated in FIG. 1.

Monitoring controller 38 provides access to one or more of the vehicle systems based upon at least one number that is transmitted from the smart key to the monitoring controller 38. This process is described above in great detail. Monitoring controller 38 also has the capability of being reconfigured (or reconfiguring itself to accept or deny access to the vehicle by using the operator's smart keys. An operator's smart key in this context is a smart key used by an operator to gain operational access to the vehicle, such as access sufficient to start it, or access sufficient to operate the various hydraulic actuators.

One can program controller 38 in the field to provide access to a new operator smart key, to continue providing access to an existing operator's smart key, and to deny access to the vehicle to an operator's smart key which previously had access. A key can be added, a key can maintain its access, or a key can be denied access as a part of this reprogramming process. All three of these capabilities are provided by controller 38 when it interoperates with the operator's smart key and a second smart key, called the “master smart key” or “master key”, which heretofore has not been mentioned.

The master smart key is a smart key as shown in FIG. 1. It also has at least one number stored in its internal memory that can be transmitted from the master key to the controller 38 to thereby identify the master key to controller 38 as a special key having reprogramming capability, and not just another operator's smart key. Hence, there are two classes of keys to which the vehicle (and particularly controller 38) will respond differentially: an “operator smart key” or “operator key”, and a “master smart key” or “master key”.

The way controller 38 distinguishes between a master key and an operator key is by examining the number that each key holds. Controller 38 stores in its electronic memory a number that is correlated with the identification number stored in the master key. Controller 38 also includes a plurality of numbers in it's electronically memory, that are correlated to a corresponding plurality of operator key identification numbers. When the vehicle is made, preferably only one master key is made and provided to the owner. All the other similar vehicles preferably have a different master key.

When the operator inserts the master key and rotates the key in the ignition switch lock, controller 38 queries the key and determines its identification number. It then compares this identification number with several numbers it retains in memory to determine whether the number corresponds to a master key number or to an operator key number inside controller 38.

If the number received from the key corresponds to the master key identification number, controller 38 enters an access control programming mode of operation. The operator is made aware that he is in this programming mode by a distinctive audio signal on enunciator 84 or a distinctive visual message that is configured to appear on electronic display 82. For purposes of this feature, the message on electronic display 82 may be one or more characters, or it may be as simple as a portion of the display lighted up.

When the electronic control system enters the programming mode, it is configured to continuously poll any smart key within range to determine whether that key is an operator smart key. In practice, once the maintenance person or operator has entered the programming mode using the master key, he removes the master key and replaces the master key with an operator key which he inserts into the ignition switch. When this happens, controller 38 receives a new numeric value from the just-inserted operator smart key. Controller 38 saves this operator key value in its internal list of key identification numbers that have access to the vehicle. This process of adding the numeric value or identification number of an operator's smart key to a list of accepted or approved smart key numbers in the memory of controller 38 will later permit any operator to insert the operator's smart key having one of those numbers into the ignition switch, start and operate the vehicle. In other words, by adding the new operator smart key correlated number to its internal memory, controller 38 has provided or granted access to that operator's smart key. Similarly, by removing an operator smart key correlated number from its list of approved operator smart keys in is internal memory, it denies or removes access to the vehicle.

If the operator only wishes to use that one key he has just programmed and does not need to program a second operator key, he can merely wait. Controller 38 is configured to remain in the programming mode for a predetermined period of time and then to automatically exit the programming mode. This automatic exit is a feature that is preferred although not required. It reduces the possibility that a forgetful maintenance person may be interrupted while programming keys and leave the vicinity of the vehicle during the programming process. If the maintenance person did so, and there was no automatic termination of the programming mode, any person having an operator smart key could approach the vehicle, insert his smart key into the ignition switch, and have his smart key programmed to access the vehicle as well.

For that reason, once the vehicle has entered the programming mode, the operator or maintenance person doing the programming must begin inserting keys into the ignition switch to have them reprogrammed. Each time a new operator key is inserted into the ignition switch and is reprogrammed, the predetermined time interval is extended to give the operator/maintenance person time to remove the newly programmed key and to insert a new operator smart key to be programmed. Each time a successive new key is programmed, the predetermined time interval is extended again. Thus, if controller 38 is configured to wait for thirty (30) seconds (the predetermined time interval) for an operator to insert an operator key, the operator would have thirty (30) seconds in which to insert the first key to be programmed. Once the first key was programmed, if the operator waited another thirty (30) seconds and did not insert a second operator key, the vehicle would automatically exit the programming mode. The vehicle would therefore have been in the programming mode for a minute. If the operator placed the vehicle in the programming mode by inserting the master key and waited thirty (30) seconds (assuming 30 seconds is the predetermined time interval) and did not insert any operator's smart key to be programmed during that interval, the control system would automatically leave the programming mode of operation.

When the system leaves the programming mode of operation, controller 38 is configured to signal I/O controller 52 over CAN bus 44 to turn off electronic display 82. If electronic display 82 is a simple light, then the light is turned off or otherwise changed in its mode of operation from its mode of operation when in the programming mode. Alternatively, if electronic display 82 is configured to display alphanumeric characters, those displayed characters can be changed indicate that the system has left the programming mode.

Another preferred configuration of the system (and in particular, controller 38) is the automatic disabling of operator smart keys that are not reprogrammed during the programming mode of operation. This disablement of all operator smart keys that are not resubmitted or reenrolled during programming happens automatically. Assume for example, that six (6) keys, A, B, C, D, E, and F are all programmed to have access to the vehicle. In this case, the smart key identification numbers of all of these six (6) operator smart keys are maintained in a list inside the memory of controller 38.

In this example, when the operator or maintenance person enters the programming mode using the master smart key, all of the existing operator smart keys' identification numbers in controller 38's list of operator smart keys permitted to operate the vehicle is deleted. The only way these keys may be reenabled or reconfigured to have access to the vehicle is by inserting them into the ignition switch lock during the programming mode of operation. Thus, if the operator or maintenance person wished to remove keys D, E, and F from the system (i.e., to disable keys D, E, and F) the operator or maintenance person would merely gather together keys A, B, and C and reprogram them in the manner described above. At the end of this reprogramming process, the operator smart key identification numbers for smart keys D, E, and F would be automatically deleted and only keys A, B, and C would be provided with access to the vehicle.

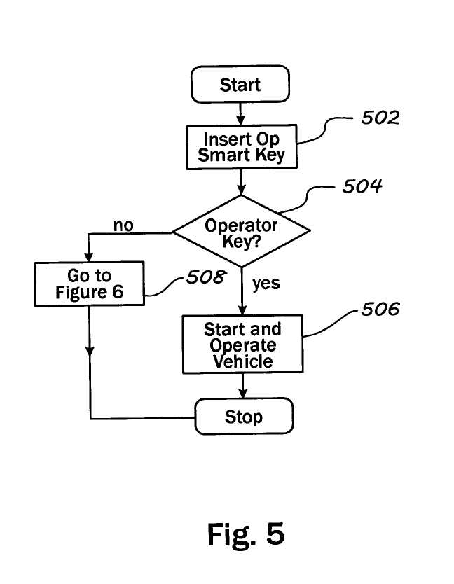

FIG. 5 illustrates the operation of the system in response to the operator inserting a smart key into the vehicle. In block 502, the operator inserts a smart key into the vehicle ignition switch lock. In block 504, controller 38 compares the identification number in that key with its list of key identification numbers to determine whether the sensed smart key identification number is equivalent to an approved operator smart key. If so, in block 506, controller 38 permits the vehicle to be started and used.

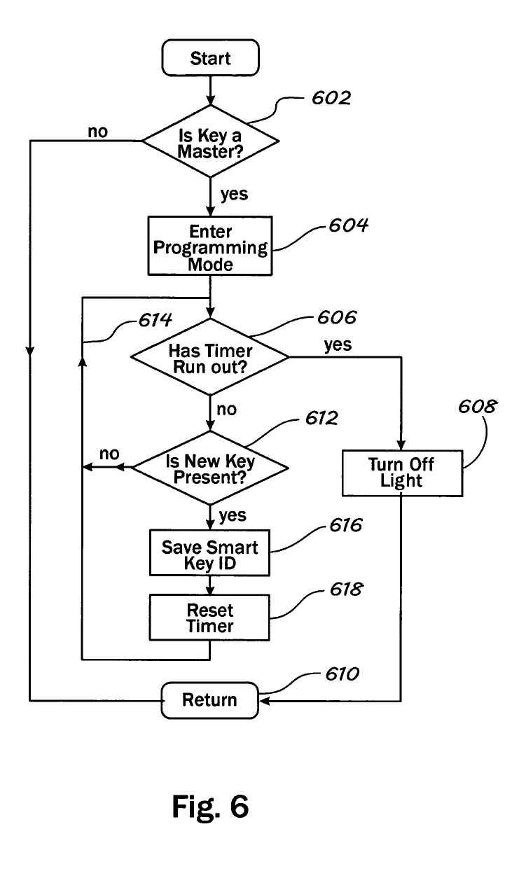

Alternatively, however, if the key is not an approved operator smart key in the memory circuits of controller 38, then execution continues with block 508. Block 508 includes the process or program portions illustrated in FIG. 6.

Referring now to FIG. 6, the process continues at block 602. In block 602, controller 38 compares the key identification number received from the key inserted into the key switch lock with its master smart key ID number saved in its memory. If the two match, the process continues with block 604 in which controller 38 in the system enter the programming mode. In this step, controller 38 deletes the existing operator smart keys from its list in memory, sets it programming timer to a predetermined time interval, typically around thirty (30) seconds, and turns on display 82 to indicate that the system has entered in the programming mode. Once this is done, processing continues to block 606 in which the system and controller 38 determine whether the timer has run out. By “run out” we mean that the time interval of thirty (30) seconds (in this case) has elapsed. If the time has elapsed, then the system and controller 38 turn off display 82 in block 608 and the process returns in block 610 to the previous flow chart illustrated on FIG. 5.

Of course, since the timer is first set to its predetermined time interval immediately prior to the timer check in block 606, the timer will not have run out and the answer will be “no”. In this case, processing will continue to block 612 in which controller 38 determines whether a new operator smart key is present. This occurs in the preferred embodiment when the key is inserted into the ignition switch lock and rotated. Thus, the operator has about thirty (30) seconds in this embodiment to remove the master key and insert the first operator smart key into the ignition switch lock. If the operator does not insert the new key, programming follows path 614 and returns back to the timer check of block 606. This cycle of block 606 to block 612 and back to block 606 will repeat until the timer runs out if the operator never inserts a second or subsequent operator smart key. Of course, when the operator does insert a second operator smart key into the operator ignition switch lock the answer to the query in block 612 will be “yes” and the process will continue at block 616. In block 616, controller 38 saves the operator smart key ID it received and checked in block 612 to the list of accepted and enabled smart key ID's it maintains in its internal memory. Once it has done this, it continues processing at block 618 and resets the timer to its original interval, in the preferred case about thirty (30) seconds. Processing then returns back through path 614 to block 606 and again controller 38 checks to see whether the timer has run out.

At this point, if the operator or maintenance person is happy with a single key being programmed, he can simply walk away from the vehicle. The vehicle will remain in programming mode for no more than thirty (30) seconds and then will automatically exit the programming mode. Alternatively, if the operator wishes to program additional smart keys, he can simply insert that additional operator smart key into the switch and repeat the process. Since the timer is reset after each keys is programmed, the operator could keep programming operator smart keys until a sufficient number were programmed or reprogrammed.

In the system described above, controller 38 adds to a list of numbers to indicate that keys are programmed. It could alternatively program each of the accepted operator smart keys with a unique number that indicates the key is authorized to use the vehicle. Hence, “programmed to interoperate” means one or the other or both are programmed to permit the user to access the vehicle with the key.

The master key of the system described above was described as a transponder or transceiver in combination with a mechanical key. Alternatively, a master key as the term is used herein can be a transponder or transceiver alone, or a computer service tool that can be coupled to the vehicle network either by electrical conductors or via a radio transmitter coupled to the computer service tool and communicating with the receiver circuit of the vehicle.

1. A method of reprogramming a vehicle and at least one smart key to provide access to said vehicle, the method comprising the steps of:
inserting a first smart key into said vehicle determining whether said first smart key is a master key;
placing said vehicle into a programming mode if said first smart key is a master key;
inserting a second smart key into said vehicle; and
configuring said vehicle and said second smart key to interoperate to start said vehicle when the second smart key is later inserted into said vehicle.

2. The method of operating the vehicle of claim 1, wherein the step of placing said vehicle in a programming mode includes the step of placing said vehicle in said programming mode for a predetermined period of time.

3. The method of operating the vehicle of claim 2, wherein the vehicle is configured to exit said programming mode after a predetermined period of inactivity.

4. The method of operating the vehicle of claim 3, wherein said predetermined period of inactivity is extended after insertion of said second smart key.

5. The method of claim 1, said vehicle is configured to signal entry into the programming mode.

6. The method of claim 5, wherein said vehicle signals entry into the programming mode by emitting light from an indicator light.

7. The method of claim 5, wherein said vehicle is configured to signal an exit from said programming mode.

8. The method of claim 7, wherein signaling an exit from said programming mode includes changing the state of a visual signal.

9. The method of claim 1, wherein prior to said step of programming said vehicle, said vehicle was configured to be operable by at least one operator's smart key.

10. The method of claim 9, wherein said at least one operator's smart key is disabled by said step of configuring said vehicle and said second smart key.

11. The method of claim 10, wherein at least two operator's smart keys are disabled by said step of configuring said vehicle and said second smart key.

12. A method of preventing at least some access to a vehicle by an otherwise access-granting operator smart key, comprising the steps of:
placing said vehicle into a programming mode;
inserting a second operator's smart key different from said access-granting operator's smart key;
programming said second operator's smart key and said vehicle to interoperate to start said vehicle after entering said programming mode;
substantially simultaneously programming said access-granting operator's smart key and said vehicle to interoperate to deny access to said vehicle using when said access-granting operator's smart key is used; and
exiting said programming mode.

13. The method of claim 12, wherein said step of placing said vehicle in a programming mode includes a step of inserting a master key into an ignition switch of said vehicle, wherein said master key is different from said access-granting operator's smart key and said second operator smart key.

14. The method of claim 13 wherein said step of placing said vehicle in a programming mode includes the step of placing said vehicle in the programming mode for a predetermined period of time.

15. The method of claim 14, wherein said vehicle signals entry into said programming mode by emitting light from an indicator light.

16. The method of claim 15, wherein said vehicle is configured to signal an exit from said programming mode.

17. The method of claim 16, wherein signaling an exit from said programming mode includes turning off said indicator light.

18. The method of claim 12, further comprising a step of programming a third operator smart key and said vehicle to interoperate to start said vehicle after said step of programming said second operator key and before said step of exiting said programming mode.

19. A system for controlling access to a vehicle, comprising:
a controller in said vehicle including a radio transceiver configured to communicate with a smart key;
a master smart key having at least one numeric value stored therein to indicate the identity of the master smart key; and
a first operator smart key having at least a second numeric value stored therein to indicate the identity of the first operator smart key;
wherein the controller is configured (1) to communicate with the master smart key when the master smart key is inserted into the vehicle, (2) to receive the at least one numeric value from the master smart key, (3) to enter into a vehicle access programming mode based at least upon the value of the at least one numeric value, (4) to receive the first operator smart key while in the programming mode, and (5) to program the controller and first operator smart key to interoperate to provide vehicle access to the first operator smart key.

20. The system of claim 19, wherein the access provided by the first operator smart key after programming is the ability to start an engine of the vehicle.

21. The system of claim 20, further comprising visual indicia operably coupled to the controller, and further wherein the controller is configured to turn the indicia on when the vehicle enters the programming mode.

22. The system of claim 21, wherein the controller is configured to exit the programming mode a predetermined time interval after it enters the programming mode.

23. The system of claim 22, wherein the controller is configured to extend the predetermined time interval whenever an operator smart key is reprogrammed.

24. The system of claim 1, wherein each of the first smart key, the second smart key and the master key includes both mechanical key portion and a digital communications circuit responsive to radio communications, the mechanical key portion being interoperable with a vehicle key switch, the mechanical key portion further having mechanical lock detents.

25. The system of claim 24, wherein the mechanical key portion and the transponder are mechanically coupled together, and further wherein the digital communications circuit includes a transponder responsive to radio signals transmitted by the vehicle.

26. The system of claim 25, wherein the transponder is molded together with the mechanical key portion.

27. The method of claim 19, wherein prior to programming the vehicle and first operator smart key, said controller was configured to be operable by at least another operator smart key.

28. The method of claim 27, wherein the controller is configured to disable said at least another operator smart key when said controller programs the controller and the first operator smart key to interoperate to provide vehicle access to the first operator smart key.

29. The method of claim 28, wherein said at least another operator smart key includes at least two operator smart keys.
